(19) United States
(12) Patent Application Publication
(10) Pub. No.: US 2013/0325846 A1
(43) Pub. Date: Dec. 5, 2013

(54) LATENT COLLABORATIVE RETRIEVAL

(71) Applicants: JASON WESTON, Brooklyn, NY (US); Ron Weiss, New York, NY (US); Adam Berenzweig, Brooklyn, NY (US); Chong Wang, (US)

(72) Inventors: JASON WESTON, Brooklyn, NY (US); Ron Weiss, New York, NY (US); Adam Berenzweig, Brooklyn, NY (US); Chong Wang, (US)

(73) Assignee: Google Inc., Mountain View, CA (US)

(21) Appl. No.: 13/486,696

(22) Filed: Jun. 1, 2012

(51) Int. Cl. G06F 17/30

(52) U.S. Cl. 707/722; 707/E17.014

(57) ABSTRACT

A method, computer program product, and computer system for latent collaborative retrieval are described. A first mathematical representation of a query received from a user is generated. A second mathematical representation of a user profile is generated. A plurality of mathematical representations associated with a plurality of items is accessed. The first mathematical representation, the second mathematical representation, and the plurality of mathematical representations are transformed to have a uniform length. A first results subset of items is generated, based upon, at least in part, a first similarity measurement of the first mathematical representation and the plurality of mathematical representations. A second result subset of items is generated based upon, at least in part, a second similarity measurement of the second mathematical representation and the plurality of mathematical representations. A result set of items is generated based upon, at least in part, the first and second result subsets.

### TECHNICAL FIELD

This disclosure relates to the retrieval/recommendation of items, and more particularly, to the retrieval/recommendation of items using latent collaborative retrieval.

### BACKGROUND

A growing number of applications and web pages seamlessly blend the traditional tasks of data retrieval and data recommendation. For example, when a user shops for a product online, the applications and web pages used by the user often recommend items that are similar to the item the user has requested/purchased. However, many retrieval processes do not take into account the user's personal preferences (e.g., other items queried/bought/reviewed) when making such recommendation and instead focus mainly on the item that was queried by the user. Another example of retrieval and recommendation may include the automatic creation of playlists for music players. Specifically, a user may request the creation of a playlist of songs based upon a query (e.g., a seed track, an artist, and/or genre). However, the tracks that populate the playlist may not include tracks that are based upon the profile and/or past personal preferences of the user.

### SUMMARY OF DISCLOSURE

In one implementation, a computer-implemented method for latent collaborative retrieval includes generating a first mathematical representation of a query received from a user and a second mathematical representation of a user profile associated with the user. A plurality of mathematical representations associated with a plurality of items are accessed. The first mathematical representation, the second mathematical representation, and the plurality of mathematical representations associated with the plurality of items are transformed to have a uniform length. A first result subset of items chosen from the plurality of items is generated based upon, at least in part, a first similarity measurement of the first mathematical representation and the plurality of mathematical representations associated with the plurality of items. A second result subset of items chosen from the plurality of items is generated based upon, at least in part, a second similarity measurement of the second mathematical representation and the plurality of mathematical representations associated with the plurality of items. A result set of items chosen from the plurality of items is generated based upon, at least in part, the first result subset and the second result subset.

One or more of the following features may be included. The first mathematical representation, the second mathematical representation, and the plurality of mathematical representations associated with the plurality of items may be vector-based representations. The user profile associated with the user may include one or more of: a query history of the user; one or more items associated with the user; one or more user-specified preferences; and one or more user characteristics. Accessing the plurality of mathematical representations associated with the plurality of items may include retrieving the plurality of mathematical representations associated with the plurality of items from a database. The plurality of mathematical representations associated with the plurality of items all may have a common length. The computing device may set the common length equal to a shortest length of one or more of the first mathematical representation, the second mathematical representation, and the plurality of mathematical representations associated with the plurality of items. Transforming the first mathematical representation, the second mathematical representation, and the plurality of mathematical representations associated with the plurality of items to have the uniform length may include using a transformation matrix operation.

In another implementation, a computer program product residing on a computer readable medium has a plurality of instructions stored on it. When executed by a processor, the plurality of instructions cause the processor to perform operations including generating a first mathematical representation of a query received from a user and a second mathematical representation of a user profile associated with the user. A plurality of mathematical representations associated with a plurality of items are accessed. The first mathematical representation, the second mathematical representation, and the plurality of mathematical representations associated with the plurality of items are transformed to have a uniform length. A first result subset of items chosen from the plurality of items is generated based upon, at least in part, a first similarity measurement of the first mathematical representation and the plurality of mathematical representations associated with the plurality of items. A second result subset of items chosen from the plurality of items is generated based upon, at least in part, a second similarity measurement of the second mathematical representation and the plurality of mathematical representations associated with the plurality of items. A result set of items chosen from the plurality of items is generated based upon, at least in part, the first result subset and the second result subset.

One or more of the following features may be included. The first mathematical representation, the second mathematical representation, and the plurality of mathematical representations associated with the plurality of items may be vector-based representations. The user profile associated with the user may include one or more of: a query history of the user; one or more items associated with the user; one or more user-specified preferences; and one or more user characteristics. Accessing the plurality of mathematical representations associated with the plurality of items may include retrieving the plurality of mathematical representations associated with the plurality of items from a database. The plurality of mathematical representations associated with the plurality of items all may have a common length. The computing device may set the common length equal to a shortest length of one or more of the first mathematical representation, the second mathematical representation, and the plurality of mathematical representations associated with the plurality of items. Transforming the first mathematical representation, the second mathematical representation, and the plurality of mathematical representations associated with the plurality of items to have the uniform length may include using a transformation matrix operation.

In another implementation, a computer system including a processor and memory is configured to perform operations including generating a first mathematical representation of a query received from a user and a second mathematical representation of a user profile associated with the user. A plurality of mathematical representations associated with a plurality of items are accessed. The first mathematical representation, the second mathematical representation, and the plurality of mathematical representations associated with the plurality of items are transformed to have a uniform length. A first result subset of items chosen from the plurality of items is generated based upon, at least in part, a first similarity measurement of the first mathematical representation and the plurality of mathematical representations associated with the plurality of items. A second result subset of items chosen from the plurality of items is generated based upon, at least in part, a second similarity measurement of the second mathematical representation and the plurality of mathematical representations associated with the plurality of items. A result set of items chosen from the plurality of items is generated based upon, at least in part, the first result subset and the second result subset.

One or more of the following features may be included. The first mathematical representation, the second mathematical representation, and the plurality of mathematical representations associated with the plurality of items may be vector-based representations. The user profile associated with the user may include one or more of: a query history of the user; one or more items associated with the user; one or more user-specified preferences; and one or more user characteristics. Accessing the plurality of mathematical representations associated with the plurality of items may include retrieving the plurality of mathematical representations associated with the plurality of items from a database. The plurality of mathematical representations associated with the plurality of items all may have a common length. The computing device may set the common length equal to a shortest length of one or more of the first mathematical representation, the second mathematical representation, and the plurality of mathematical representations associated with the plurality of items. Transforming the first mathematical representation, the second mathematical representation, and the plurality of mathematical representations associated with the plurality of items to have the uniform length may include using a transformation matrix operation.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an LCR process coupled to a distributed computing network;

FIG. 2 is a flowchart of one embodiment of the LCR process of FIG. 1;

FIG. 3 is a diagrammatic view of the LCR process of FIG. 1 coupled to a music distribution system; and

FIG. 4 is a diagrammatic view of a computing device executing the LCR process of FIG. 1.

Like reference symbols in the various drawings indicate like elements.

### DETAILED DESCRIPTION OF THE PREFERRED EMBODIMENTS

### System Overview:

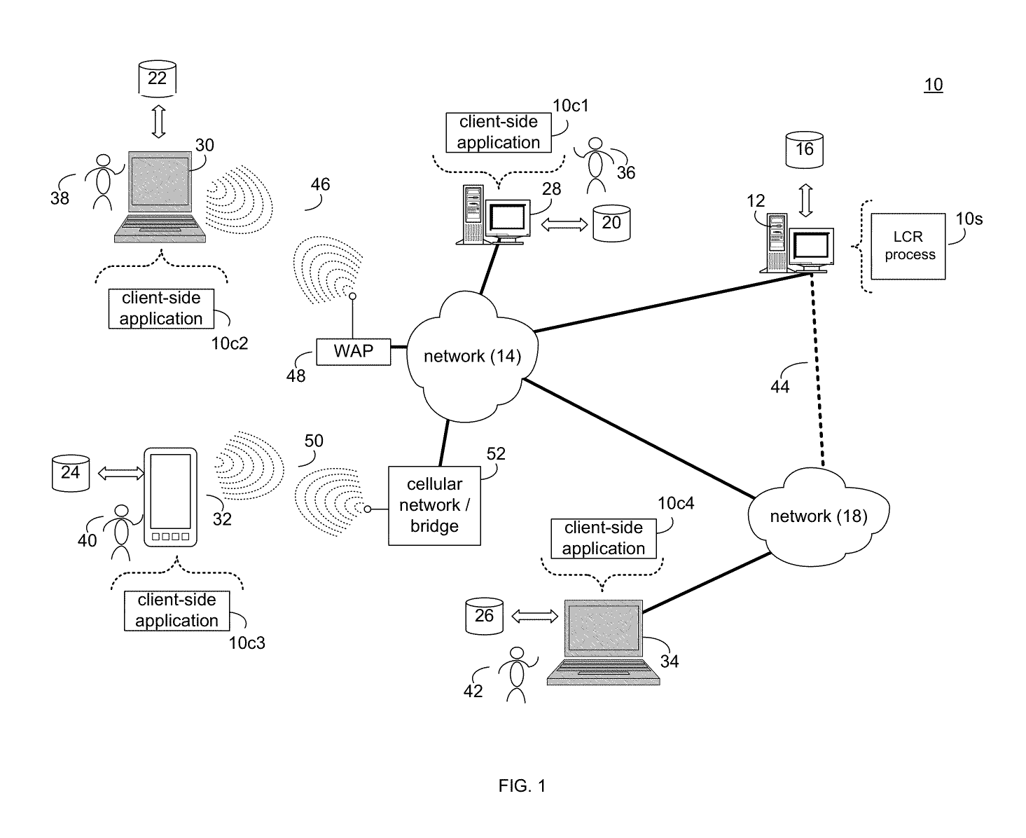

Referring to FIG. 1, there is shown LCR (i.e., Latent Collaborative Retrieval) process 10. For the following discussion, it is intended to be understood that LCR process 10 may be implemented in a variety of ways. For example, LCR process 10 may be implemented as a server-side process, a client-side process, or a server-side/client-side process.

Accordingly, LCR process 10 may be implemented as a purely server-side process via LCR process 10s. Alternatively, LCR process 10 may be implemented as a purely client-side process via one or more of client-side application 10c1, client-side application 10c2, client-side application 10c3, and client-side application 10c4. Alternatively still, LCR process 10 may be implemented as a server-side/client-side process via LCR generation process 10s in combination with one or more of client-side application 10c1, client-side application 10c2, client-side application 10c3, and client-side application 10c4.

Accordingly, LCR process 10 as used in this disclosure may include any combination of LCR process 10s, client-side application 10c1, client-side application 10c2, client-side application 10c3, and client-side application 10c4.

LCR process 10s that may reside on and may be executed by computer 12, which may be connected to network 14 (e.g., the Internet or a local area network). Examples of computer 12 may include but are not limited to a single server computer, a series of server computers, a single personal computer, a series of personal computers, a mini computer, a mainframe computer, or a computing cloud. The various components of computer 12 may execute one or more operating systems, examples of which may include but are not limited to: Microsoft Windows Server™; Novell Netware™; Redhat Linux™, Unix, or a custom operating system, for example.

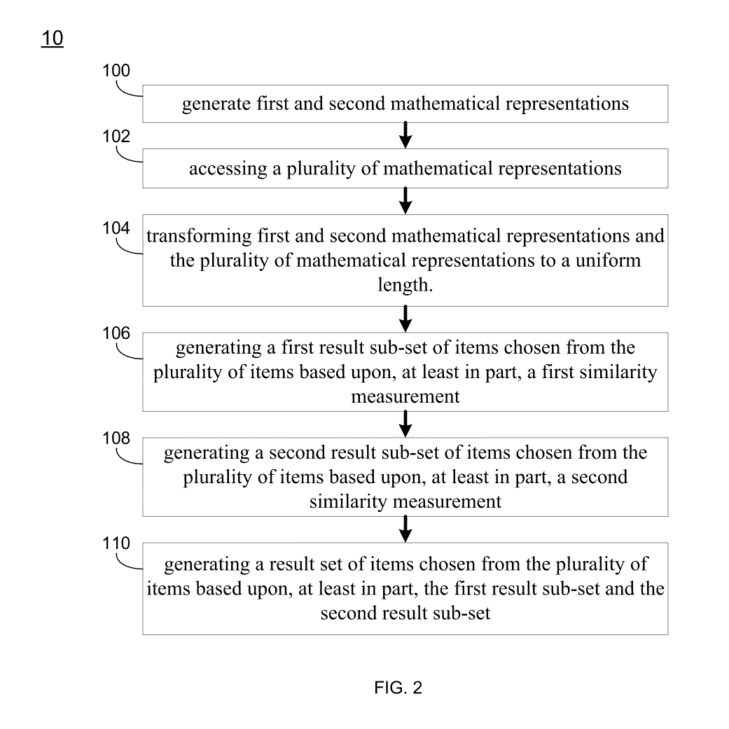

Referring also to FIG. 2 and as will be discussed below in greater detail, LCR process 10 may generate 100 a first mathematical representation of a query received from a user and a second mathematical representation of a user profile associated with the user. LCR process 10 may access 102 a plurality of mathematical representations associated with a plurality of items and may transform 104 the first mathematical representation, the second mathematical representation, and the plurality of mathematical representations associated with the plurality of items to have a uniform length. LCR process 10 may generate 106 a first result subset of items chosen from the plurality of items based upon, at least in part, a first similarity measurement of the first mathematical representation and the plurality of mathematical representations associated with the plurality of items. LCR process 10 may also generate 108 a second result subset of items chosen from the plurality of items based upon, at least in part, a second similarity measurement of the second mathematical representation and the plurality of mathematical representations associated with the plurality of items. LCR process 10 may further generate 110 a result set of items chosen from the plurality of items based upon, at least in part, the first result subset and the second result subset.

The instruction sets and subroutines of LCR process 10s, which may be stored on storage device 16 coupled to computer 12, may be executed by one or more processors (not shown) and one or more memory architectures (not shown) included within computer 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

LCR process 10 may be accessed via client-side application 10c1, client-side application 10c2, client-side application 10c3, and client-side application 10c4. Examples of client-side application 10c1, client-side application 10c2, client-side application 10c3, and client-side application 10c4 may include but are not limited to a standard web browser, a customized web browser, a game console user interface, a television user interface, or a specialized application (e.g., an application running on a mobile platform). The instruction sets and subroutines of client-side application 10c1, client-side application 10c2, client-side application 10c3, and client-side application 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Client electronic devices 28, 30, 32, 34 may each execute an operating system, examples of which may include but are not limited to Apple iOS™ Microsoft Windows™, Android™, Redhat Linux™, or a custom operating system.

Storage devices 20, 22, 24, 26 may include but are not limited to: hard disk drives; flash drives, tape drives; optical drives; RAID arrays; random access memories (RAM); and read-only memories (ROM). Examples of client electronic devices 28, 30, 32, 34 may include, but are not limited to, personal computer 28, laptop computer 30, data-enabled, cellular telephone 32, notebook computer 34, a server computer (not shown), a data-enabled television (not shown), and a dedicated network device (not shown).

Users 36, 38, 40, 42 may access computer 12 and LCR process 10 directly through network 14 or through secondary network 18. Further, computer 12 may be connected to network 14 through secondary network 18, as illustrated with phantom link line 44.

The various client electronic devices may be directly or indirectly coupled to network 14 (or network 18). For example, personal computer 28 is shown directly coupled to network 14 via a hardwired network connection. Further, notebook computer 34 is shown directly coupled to network 18 via a hardwired network connection. Laptop computer 30 is shown wirelessly coupled to network 14 via wireless communication channel 46 established between laptop computer 30 and wireless access point (i.e., WAP) 48, which is shown directly coupled to network 14. WAP 48 may be, for example, an IEEE 802.11a, 802.11b, 802.11g, Wi-Fi, and/or Bluetooth device that is capable of establishing wireless communication channel 46 between laptop computer 30 and WAP 48. Data-enabled, cellular telephone 32 is shown wirelessly coupled to network 14 via wireless communication channel 50 established between data-enabled, cellular telephone 32 and cellular network/bridge 52, which is shown directly coupled to network 14.

### The LCR Process:

As stated above and as will be discussed below in greater detail, LCR process 10 may generate 100 a first mathematical representation of a query received from a user and a second mathematical representation of a user profile associated with the user. LCR process 10 may access 102 a plurality of mathematical representations associated with a plurality of items and may transform 104 the first mathematical representation, the second mathematical representation, and the plurality of mathematical representations associated with the plurality of items to have a uniform length. LCR process 10 may generate 106 a first result subset of items chosen from the plurality of items based upon, at least in part, a first similarity measurement of the first mathematical representation and the plurality of mathematical representations associated with the plurality of items. LCR process 10 may also generate 108 a second result subset of items chosen from the plurality of items based upon, at least in part, a second similarity measurement of the second mathematical representation and the plurality of mathematical representations associated with the plurality of items. LCR process 10 may further generate 110 a result set of items chosen from the plurality of items based upon, at least in part, the first result subset and the second result subset.

As used in this document, collaborative retrieval may refer to various methodologies for combining data retrieval and data recommendation into a single predictor. For example, if a user enters a query string into e.g., a search engine, a collaborative retrieval process may combine other factors (such as e.g., the user's query history, preferences, and characteristics) with the query string for the purpose of retrieving relevant items and providing a more robust result set. Accordingly, if the search engine described above is included within a music distribution website/platform, when a user of this search engine enters a query, a collaborative retrieval process may consider e.g., the tracks that you previously listened to, the tracks that you previously purchased, and any likes/dislikes identified in your user profile to provide a more targeted result set.

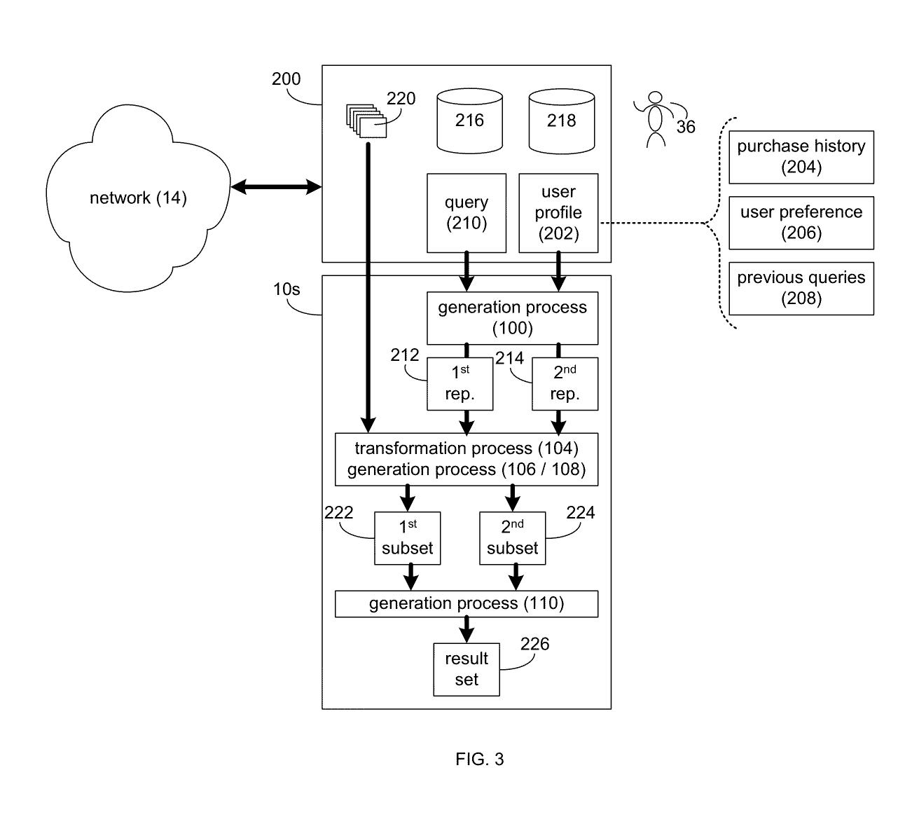

Continuing with the above-stated example and referring also to FIG. 3, assume that user 36 is a user of music distribution system 200 that is configured to allow user 36 to review and purchase music tracks. Music distribution system 200 may be coupled to and accessed through network 14. Further, assume that user 36 is a member of music distribution system 200 and, accordingly, has a defined user profile (e.g., user profile 202). User profile 202 may define various pieces of information concerning user 36, examples of which may include but are not limited to: the purchasing habits of user 36 (via purchase history 204), the likes/dislikes of user 36 (via user preferences 206), and previous queries executed by user 36 (via previous queries 208). Further, assume that user 36 is an R&B fan and is looking for new R&B music. Accordingly, user 36 may define query 210 within music distribution system 200.

In this particular example, LCR process 10 may be a portion of, included within, or called from within music distribution system 200. Upon user 36 defining query 210, LCR process 10 may generate 100 first mathematical representation 212 of query 210 received from user 36 and second mathematical representation 214 of user profile 202 associated with user 36. In some embodiments, LCR process 10 may receive query 210 from user 36 who may be using e.g., client device 28. Additionally, user 36 may enter query 210 via e.g., a web page or custom application associated with music distribution system 200. Further, query 210 may be transmitted to LCR process 10 over network 14 and/or network 18.

When generating 100 first mathematical representation 212 of query 210, LCR process 10 may convert query 210 into a numerical representation (e.g., a feature vector or other vector-based representation). For example, assume that LCR process 10 defines a dictionary (e.g., dictionary 216) of e.g., one million unique words that are frequently used within queries. Further, assume that each feature vector (e.g., first mathematical representation 212) includes one million entities that are mapped to the words included within dictionary 216 (wherein each entity is mapped to one of the one million unique words within dictionary 216).

Accordingly, assume that when query 210 is processed by LCR process 10 to generate 100 the above-described feature vector (i.e., first mathematical representation 212) representative of query 210, the feature vector generated may include one million entities, wherein each binary one within the feature vector is mapped to a word within dictionary 216 that is included within query 210, while each binary zero within the feature vector is mapped to a word within dictionary 216 that is not included within query 210.

Accordingly, if query 210 includes three words, the feature vector (e.g., first mathematical representation 212) generated 100 for query 210 may include 3 binary ones (identifying the three words within dictionary 216 that are included within query 210) and 999,997 binary zeros (identifying the 999,997 words within dictionary 216 that are not included within query 210). In the interest of conserving space, the feature vector (e.g., first mathematical representation 212) generated by LCR process 10 may be configured to only define the binary ones (as opposed to also defining all of the binary zeros).

As discussed above, user profile 202 may identify the purchasing habits of user 36 (via purchase history 204), the likes/dislikes of user 36 (via user preferences 206), and previous queries executed by user 36 (via previous queries 208). Purchasing history 204 may include e.g., a list of music files purchased by user 36, and a list of music files previewed by user 36. User preferences 206 may define e.g., the music genres liked/disliked by user 36, the favorite artists of user 36, and wish list items for user 36. User profile 202 may further define user specific characteristics, such as the location of residence, age, gender, or other similar information for user 36.

When generating 100 second mathematical representation 214 of user profile 202, LCR process 10 may convert some or all of user profile 202 into a numerical representation (e.g., a feature vector or other vector-based representation). For example, assume that the portion of user profile 202 that is used by LCR process 10 includes a set of tracks that a user is known to own (e.g., purchase history 204). Further and for this example, assume that music distribution system 200 includes a database (e.g., database 218) that identifies four million tracks that are available for purchase/preview by user 36 via music distribution system 200.

Accordingly, when generating 100 second mathematical representation 214 that is representative of user profile 202, LCR process 10 may generate a feature vector (e.g., second numerical representation 214) that includes four million entities (one corresponding to each music track defined within database 218 and available via music distribution system 200). The value of each entity within this feature vector may be a binary zero if user 36 does not own the corresponding music track within database 218 and may be a binary one if user 36 does own the corresponding music track within database 218.

While in this particular example, the feature vectors for query 210 and user profile 202 (i.e., first numerical representation 212 and second numerical representation 214, respectively) are different lengths (one million entities versus four million entities), this is for illustrative purposes only and is not intended to be a limitation of this disclosure. Specifically, these two feature vectors may be the same length.

As discussed above, assume that music distribution system 200 includes a database (e.g., database 218) that identifies four million tracks (which also may be stored within database 218) that are available for purchase/preview by user 36 via music distribution system 200. Further, assume that a mathematical representation (e.g., an item feature vector) was generated and is available for each of these four million tracks, wherein each item feature vector is generated by LCR process 10 based upon the content/characteristics of the related item (i.e., the music track) and is stored within database 218. Accordingly, a plurality of mathematical representations 220 (e.g., four million item feature vectors) may be generated that are based upon the plurality of tracks included within database 218.

The manner in which the plurality of mathematical representations 220 are generated by LCR process 10 may vary depending upon the type of items being represented. For example, if the items being represented are web pages, LCR process may generate the plurality of mathematical representations 220 in a fashion similar to the manner in which first mathematical representation 212 is generated (e.g., mapping words within the webpages to words within dictionary 216). If the items being represented are music tracks, LCR process 10 may establish a track directory (not shown) that defines e.g., every possible music track available and each of the plurality of mathematical representations 220 would map to a single track defined within this track directory. For example, if the track directory (not shown) identifies 10,000,000 music tracks, each of the plurality of mathematical representations 220 may include 10,000,000 entities, wherein all but one of the entities is a binary zero and the sole binary one identifies the appropriate track within the track directory (not shown).

LCR process 10 may access 102 this plurality of mathematical representations 220 associated with, in this example, the plurality of music track included within database 218. While the plurality of mathematical representations 220 in the example correspond to a plurality of music tracks, this is for illustrative purposes only and is not intended to be a limitation of this disclosure, as other configurations are possible. For example, plurality of mathematical representations 220 may correspond to a plurality of products within a product catalog, a plurality of vacation destinations, a plurality of available hotel rooms, a plurality of webpages, or a plurality of books.

When accessing 202 the plurality of mathematical representations 220, LCR process 10 may retrieve the plurality of mathematical representations 220 (i.e., the plurality of item feature vectors) associated with e.g., the plurality of music tracks within database 218. As each of the plurality of mathematical representations 220 are defined based upon the content/characteristics of each of the tracks included within database 218, each of the plurality of mathematical representations 220 stored within database 218 may be same length.

As discussed above, first mathematical representation 212, second mathematical representation 214, and the plurality of mathematical representations 220 may be different lengths. Unfortunately, when first mathematical representation 212, second mathematical representation 214, and the plurality of mathematical representations 220 are different lengths, the comparison of these representations becomes difficult. Specifically, when first mathematical representation 212, second mathematical representation 214, and the plurality of mathematical representations 220 are the same length (e.g., common length vectors), comparison of first mathematical representation 212, second mathematical representation 214, and the plurality of mathematical representations 220 is simplified, as LCR process 10 may simply count the number of similar entities within these common length vectors. Alternatively, LCR process 10 may perform a dot product operation to determine the level of similarity e.g., between a pair of vectors. However, prior to any similarity measurements being performed, LCR process 10 may transform 104 first mathematical representation 212, second mathematical representation 214, and the plurality of mathematical representations 220 associated with e.g., the plurality of tracks included within database 218 so that they have a uniform length.

When LCR process 10 transforms 104 first mathematical representation 212, second mathematical representation 214, and the plurality of mathematical representations 220 into the same length, this process may be accomplished in a variety of ways. For example, LCR process 10 may normalize first mathematical representation 212, second mathematical representation 214, and the plurality of mathematical representations 220 to have the same length. Concerning the manner in which this is performed, LCR process 10 may set the uniform length equal to a shortest length of any of first mathematical representation 212, second mathematical representation 214, and the plurality of mathematical representations 220. Alternatively, LCR process 10 may set the uniform length to be equal to a length that is smaller than the shortest of any of first mathematical representation 212, second mathematical representation 214, and the plurality of mathematical representations 220.

When transforming 104 first mathematical representation 212, second mathematical representation 214, and the plurality of mathematical representations 220, LCR process 104 may perform a transformation matrix operation (using one or more transformation matrices) to transform first mathematical representation 212, second mathematical representation 214, and the plurality of mathematical representations 220 into a common length. For example, LCR process 10 may use machine learning to construct a transformation matrix for each of first mathematical representation 212, second mathematical representation 214, and the plurality of mathematical representations 220.

For example, assume that first mathematical representation 212 has a length of 10,000.000 entities. Further, assume that second mathematical representation 214 has a length of 100,000,000 entities. To make first mathematical representation 212 have a common length of e.g., 100 entities, LCR process 10 may use a transformation matrix that may e.g., include 100 sets of 10,000,000 entities (i.e. for a total of 1,000,000,000 entities). To make second mathematical representation 214 have a common length of e.g., 100 entities, LCR process 10 may use a transformation matrix that may e.g., include 100 sets of 100,000,000 (i.e. for a total of 10,000,000,000 entities).

To transform 104 first mathematical representation 212 into a 100 entity length vector, LCR process 10: may calculate the first entity (within the 100 entity length vector) by determining the vector similarity between the first set (of the 100 sets of 10,000,000 entities within the transformation matrix) and the first mathematical representation 212; may calculate the second entity (within the 100 entity length vector) by determining the vector similarity between the second set (of the 100 sets of 10,000,000 entities within the transformation matrix) and the first mathematical representation 212; and may repeat this process until the one hundredth entity is calculated, thus resulting in first mathematical representation 212 being transformed 104 into a one hundred entity length representation by LCR process 10. This may be referred to as the “embedding vector” for first mathematical representation 212.

To transform 104 second mathematical representation 214 into a 100 entity length vector, LCR process 10: may calculate the first entity (within the 100 entity length vector) by determining the vector similarity between the first set (of the 100 sets of 100,000,000 entities within the transformation matrix) and the second mathematical representation 214; may calculate the second entity (within the 100 entity length vector) by determining the vector similarity between the second set (of the 100 sets of 100,000,000 entities within the transformation matrix) and the second mathematical representation 214; and may repeat this process until the one hundredth entity is calculated, thus resulting in second mathematical representation 214 being transformed 104 into a one hundred entity length representation by LCR process 10. This may be referred to as the “embedding vector” for second representation 214.

LCR process 10 may perform a similar procedure to transform 104 each of the plurality of mathematical representations 220 into a plurality of one hundred entity length representation, thus resulting in first mathematical representation 212, second mathematical representation 214, and the plurality of mathematical representations 220 all having a one hundred entity length.

Once first mathematical representation 212, second mathematical representation 214, and the plurality of mathematical representations 220 have been transformed 104 into a common length, LCR process 10 may generate 106 first result subset of items 222 (chosen from the plurality of items defined within database 218) based upon, at least in part, a first similarity measurement of first mathematical representation 212 and each of the plurality of mathematical representations 220 associated with the plurality of items defined within database 218. An example of such a first similarity measurement may be determined by e.g., counting how many entities are common within the one hundred entity length representations or performing a dot product operation.

LCR process 10 may also generate 108 second result subset of items 224 (chosen from the plurality of items defined within database 218) based upon, at least in part, a second similarity measurement of second mathematical representation 214 and each of the plurality of mathematical representations 220 associated with the plurality of items defined within database 218. An example of such a second similarity measurement may be determined by e.g., counting how many entities are common within the one hundred entity length representations or performing a dot product operation.

LCR process 10 may generate 110 a single result set of items (e.g., result set 226) (chosen from the plurality of items defined within database 218) based upon an overall similarity measurement of first mathematical representation 212 (e.g., the query string feature vector), second mathematical representation 214 (e.g., the user profile feature vector), and each of the plurality of mathematical representations 220 associated with the plurality of items included within database 218. As discussed above, result set 226 may define groups of various items such as e.g., a plurality of products within a product catalog, a plurality of vacation destinations, a plurality of available hotel rooms, a plurality of webpages, a plurality of music tracks, a plurality of videos, a plurality of restaurants, or a plurality of books.

LCR process 10 may use these overall similarity measurements to rank/order the individual items defined within result set 226, wherein the ranking/order indicates the relevance of each item with respect to the user profile, query, and item content. For example, LCR process 10 may be configured to only present the top “n” items included within result set 226 to e.g., user 36. Alternatively, LCR process 10 may be configured to present all of the items included within result set 226 to e.g., user 36. LCR process 10 may or may not be configured to provide user 36 with these overall similarity measurements. LCR process 10 may be configured to calculate the above-described overall similarity measurement by summing the above described first similarity measurement and second similarity measurement.

Further technical explanation of LCR process 10 may be found in the paper entitled “Latent Collaborative Retrieval” by Jason Weston, Chong Wang, Ron Weiss, and Adam Berenzweig, which is attached hereto as Appendix A.

### General:

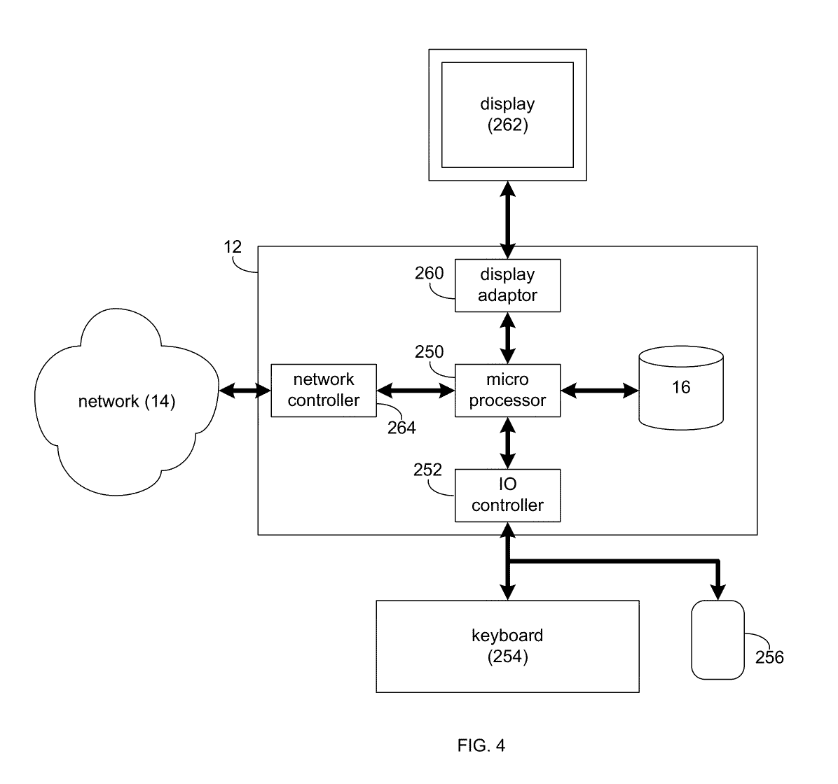

Referring also to FIG. 4, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, LCR process 10 may be substituted for computing device 12 within FIG. 4, examples of which may include but are not limited to client electronic devices 28, 30, 32, 34.

Computing system 12 may include microprocessor 250 configured to e.g., process data and execute instructions/code for LCR process 10. Microprocessor 250 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 252 may be configured to couple microprocessor 250 with various devices, such as keyboard 254, mouse 256, USB ports (not shown), and printer ports (not shown). Display adaptor 260 may be configured to couple display 262 (e.g., a CRT or LCD monitor) with microprocessor 250, while network controller 264 (e.g., an Ethernet adapter) may be configured to couple microprocessor 250 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 350) of a general purpose computer/special purpose computer/other programmable data processing apparatus (e.g., computing device 12), such that the instructions, which execute via the processor (e.g., processor 350) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
generating, by a computing device, a first mathematical representation of a query received from a user and a second mathematical representation of a user profile associated with the user;
accessing, by the computing device, a plurality of mathematical representations associated with a plurality of items;
transforming, by the computing device, the first mathematical representation, the second mathematical representation, and the plurality of mathematical representations associated with the plurality of items to have a uniform length;
generating, by the computing device, a first result subset of items chosen from the plurality of items based upon, at least in part, a first similarity measurement of the first mathematical representation and the plurality of mathematical representations associated with the plurality of items;
generating, by the computing device, a second result subset of items chosen from the plurality of items based upon, at least in part, a second similarity measurement of the second mathematical representation and the plurality of mathematical representations associated with the plurality of items; and
generating, by the computing device, a result set of items chosen from the plurality of items based upon, at least in part, the first result subset and the second result subset.

2. The computer-implemented method of claim 1, wherein the first mathematical representation, the second mathematical representation, and the plurality of mathematical representations associated with the plurality of items are vector-based representations.

3. The computer-implemented method of claim 1, wherein the user profile associated with the user includes one or more of: a query history of the user; one or more items associated with the user; one or more user-specified preferences; and one or more user characteristics.

4. The computer-implemented method of claim 1, wherein accessing the plurality of mathematical representations associated with the plurality of items includes retrieving the plurality of mathematical representations associated with the plurality of items from a database.

5. The computer-implemented method of claim 1, wherein the plurality of mathematical representations associated with the plurality of items all have a common length.

6. The computer-implemented method of claim 5, further comprising setting the uniform length equal to a shortest length of one or more of the first mathematical representation, the second mathematical representation, and the plurality of mathematical representations associated with the plurality of items.

7. The computer-implemented method of claim 1, wherein transforming the first mathematical representation, the second mathematical representation, and the plurality of mathematical representations associated with the plurality of items to have the uniform length includes using a transformation matrix operation.

8. A computer program product residing on a computer readable medium having a plurality of instructions stored thereon which, when executed by a processor, cause the processor to perform operations comprising:
generating a first mathematical representation of a query received from a user and a second mathematical representation of a user profile associated with the user;
accessing a plurality of mathematical representations associated with a plurality of items;
transforming the first mathematical representation, the second mathematical representation, and the plurality of mathematical representations associated with the plurality of items to have a uniform length;
generating a first result subset of items chosen from the plurality of items based upon, at least in part, a first similarity measurement of the first mathematical representation and the plurality of mathematical representations associated with the plurality of items;
generating a second result subset of items chosen from the plurality of items based upon, at least in part, a second similarity measurement of the second mathematical representation and the plurality of mathematical representations associated with the plurality of items; and
generating a result set of items chosen from the plurality of items based upon, at least in part, the first result subset and the second result subset.

9. The computer program product of claim 8, wherein the first mathematical representation, the second mathematical representation, and the plurality of mathematical representations associated with the plurality of items are vector-based representations.

10. The computer program product of claim 8, wherein the user profile associated with the user includes one or more of: a query history of the user; one or more items associated with the user; one or more user-specified preferences; and one or more user characteristics.

11. The computer program product of claim 8, wherein accessing the plurality of mathematical representations associated with the plurality of items includes retrieving the plurality of mathematical representations associated with the plurality of items from a database.

12. The computer program product of claim 8, wherein the plurality of mathematical representations associated with the plurality of items all have a common length.

13. The computer program product of claim 12, further comprising setting the uniform length equal to a shortest length of one or more of the first mathematical representation, the second mathematical representation, and the plurality of mathematical representations associated with the plurality of items.

14. The computer program product of claim 8, wherein transforming the first mathematical representation, the second mathematical representation, and the plurality of mathematical representations associated with the plurality of items to have the uniform length includes using a transformation matrix operation.

15. A computing system including a processor and memory configured to perform operations comprising:
generating a first mathematical representation of a query received from a user and a second mathematical representation of a user profile associated with the user;
accessing a plurality of mathematical representations associated with a plurality of items;
transforming the first mathematical representation, the second mathematical representation, and the plurality of mathematical representations associated with the plurality of items to have a uniform length;
generating a first result subset of items chosen from the plurality of items based upon, at least in part, a first similarity measurement of the first mathematical representation and the plurality of mathematical representations associated with the plurality of items;
generating a second result subset of items chosen from the plurality of items based upon, at least in part, a second similarity measurement of the second mathematical representation and the plurality of mathematical representations associated with the plurality of items; and
generating a result set of items chosen from the plurality of items based upon, at least in part, the first result subset and the second result subset.

16. The computing system of claim 15, wherein the first mathematical representation, the second mathematical representation, and the plurality of mathematical representations associated with the plurality of items are vector-based representations.

17. The computing system of claim 15, wherein the user profile associated with the user includes one or more of: a query history of the user; one or more items associated with the user; one or more user-specified preferences; and one or more user characteristics.

18. The computing system of claim 15, wherein accessing the plurality of mathematical representations associated with the plurality of items includes retrieving the plurality of mathematical representations associated with the plurality of items from a database.

19. The computing system of claim 15, wherein the plurality of mathematical representations associated with the plurality of items all have a common length.

20. The computing system of claim 19, further comprising setting the uniform length equal to a shortest length of one or more of the first mathematical representation, the second mathematical representation, and the plurality of mathematical representations associated with the plurality of items.

21. The computing system of claim 15, wherein transforming the first mathematical representation, the second mathematical representation, and the plurality of mathematical representations associated with the plurality of items to have the uniform length includes using a transformation matrix operation.
